(19) United States
(12) Patent Application Publication
(10) Pub. No.: US 2012/0241053 A1
(43) Pub. Date: Sep. 27, 2012

(54) USE OF INTERMEDIATE PIECE FOR CONNECTING MOLDED ARTICLES OF MANGANESE STEEL WITH CARBON STEEL, AND METHOD FOR CONNECTING AUSTENITIC MANGANESE STEEL CASTING PIECES WITH STANDARD RAILS

(75) Inventor: Johannes BLUMAUER, Zeltweg (AT)

(73) Assignees: VAE GmbH, Vienna (AT); VAE Eisenbahnsysteme GmbH, Zeltweg (AT)

(21) Appl. No.: 13/489,991

(22) Filed: Jun. 6, 2012

Related U.S. Application Data
(62) Division of application No. 12/733,872, filed on May 17, 2010.

(30) Foreign Application Priority Data
Oct. 5, 2007 (AT) A 1584/2007

(51) Int. Cl. B23K 35/30; C21D 9/50; B23K 1/19; C22C 38/44

(52) U.S. Cl. 148/529; 148/325; 228/262.41

(57) ABSTRACT

In an intermediate piece for connecting molded articles of manganese steel with carbon steel, in particular austenitic manganese steel casting frogs with standard rails, the intermediate piece is comprised of steel from the group of austenitic-ferritic duplex steels having a ferrite portion of <60 wt %. The method for connecting austenitic manganese steel castings with standard rails is characterized in that an austenitic-ferritic intermediate piece made of duplex steel comprising <60% ferrite is welded with the manganese steel casting and the standard rail.

This application is a divisional of prior application Ser. No. 12/733,872, filed May 17, 2010, which is the U.S. National Phase of PCT/AT2008/000338, filed Sep. 22, 2008, and claims priority to Austria Pat. App. No. A1584/2007, filed Oct. 5, 2007, and priority to all these applications is claimed and the contents of all of these applications are incorporated herein by reference. The invention relates to an intermediate piece for connecting molded articles of manganese steel with carbon steel, in particular austenitic manganese steel casting frogs with standard rails, as well as a method for connecting austenitic manganese steel castings with standard rails.

### BACKGROUND OF THE INVENTION

An austenitic manganese steel casting cannot be directly welded with standard rail steel, since a comparatively high temperature is required for welding. An austenitic manganese steel casting has the property of strongly embrittling in its texture when heated to above 300° C. because of carbide segregations, the brittle texture being subsequently maintained when cooled slowly. It is, therefore, necessary to effect heating to high temperatures and to subsequently perform rapid cooling in order to avoid such embrittlement. Such rapid cooling can, for instance, be realized by quenching in water. Carbon steel as is used as standard rail steel, in turn, has the property of embrittling during rapid cooling such that cooling after welding in that case has to be effected slowly in order to avoid embrittlement. Due to the superior strength properties, frogs and crossings in rail traffic are, as a rule, made of austenitic manganese steel castings, thus providing contradictory conditions for the heat treatment of welds. In order to be able to take into account those different requirements, intermediate pieces have been proposed between standard rails and austenitic manganese steel casting frogs, which have been selected with regard to their good weldability and an appropriate heat treatment of the respective welding connection. Such at least partially austenitic intermediate pieces, however, have relatively poorer strength properties than the adjacent standard steel and the austenitic manganese steel casting, respectively.

A method for welding austenitic manganese steel casting rail pieces and, in particular, frogs with standard rails can, for instance, be taken from AT 343712. In that known method, an intermediate piece of a lower height than the height of the upper surface of the frog or the standard rail steel, respectively, is inserted before applying a hard facing of wear-resistance manganese steel. In this manner, the fact that in the region of the welds a material of substantially lower hardness is present, which will subsequently bear the risk of becoming dented by the rolling stock, is to be accounted for. The length of such an intermediate piece was, as a rule, dimensioned to be more than 50 mm in order to avoid overlapping heat influence zones from the two welds.

When further developing that known mode of procedure, AT 350881 already proposed to limit the intermediate piece to a reduced length, with a length of between 15 and 25 mm having then had to be sufficient. That measure was intended to reduce the risk of the formation of dents on account of the substantially shorter, softer subportion of the upper surface. The basically underlying difficulties concerning sufficient hardness of the intermediate piece have, however, remain unsolved in such a configuration.

EP 391007 B1 already proposed to effect simple cooling by ambient air even during the welding of the intermediate piece with the austenitic manganese steel casting. To this end, special materials substantially comprising 6 to 11 wt % manganese, 5 to 8 wt % nickel, 17 to 20 wt % chromium, and a delta-ferrite content ranging between 5 and 15 wt % were selected. Such steels as well as other hitherto proposed steels for the intermediate piece substantially eliminated the problems involved in the direct welding of the two steels, yet the weak points in terms of fatigue limit and bending strength of the overall welding connection could not be addressed properly since the austenitic components and, in particular, the materials of the frog and of the intermediate piece only allow the achievement of a maximum tensile strength of 500 to 600 N/mm², which consequently results in dents.

### DETAILED DESCRIPTION OF THE INVENTION

The invention now aims to enhance the prevention of dents in the region of the welding connection and, in particular, in the transition region between a standard rail and austenitic manganese steel, and to provide a particularly uniform hardness and strength distribution throughout the overall connection. To solve this object, the intermediate piece according to the invention is comprised of steel from the group of austenitic-ferritic duplex steels having a ferrite portion of <60 wt %. Such steels from the group of duplex steels are characterized by a ferrite portion of up to 60 wt %, wherein, as an example of such a material, the material X2CrNiMoN22−5−3 can be mentioned, which may be regarded as a particularly preferred choice of a suitable material for the intermediate piece. Such steel has the following directional analysis:
C max 0.03%
Cr 21-23%
Ni 4.5-6.5%
Mo 2.5-3.5%
N 0.1-2.22%

A duplex-steel intermediate piece of this type having an austenite to ferrite ratio of about 50:50 not only offers excellent properties for welding both with the austenitic manganese steel, on one side, and with the perlitic rail steel (ferrite and cementite), on the other side. Due to the high ferritic portion, it has also become possible to bring the intermediate piece, by selective heat treatment prior to, during and/or after welding, to that strength which is approximately present in the region of the rail steel and of the austenitic manganese steel. With such a configuration, a residual length of the intermediate piece need not be considered any longer, since the risk of dents caused by too soft an intermediate piece material has been eliminated. It is, in particular, feasible to raise the tensile strength of the intermediate piece by such a heat treatment to 600 to 800 N/mm² after having selected the appropriate intermediate piece. In a particularly preferred manner, the intermediate piece is used in a solution-annealed and subsequently quenched form, said intermediate piece being advantageously used in a form solution-annealed at 900° C. to 1100° C. and subsequently quenched with water followed by air.

The method according to the invention, for connecting austenitic manganese steel castings with standard rails is substantially characterized in that an austenitic-ferritic intermediate piece made of duplex steel comprising <60% ferrite is welded with the manganese steel casting and the standard rail, wherein, in a preferred manner, an intermediate piece having the following directional analysis:
C max 0.03%
Cr 21-23%
Ni 4.5-6.5%
Mo 2.5-3.5%
N 0.1-2.22% is initially welded with the standard rail and subsequently welded with the austenitic manganese steel casting. In principle, the selected intermediate piece allows for cooling from the welding heat during the welding procedure by compressed air, both during the first and the second welding procedures. In order to achieve the desired strength values and, in particular, an increase in the endurance limit from about 140 N/mm² to about 190 N/mm², it may advantageously be proceeded such that the intermediate piece is solution-annealed at 900° C. to 1100° C. before welding and subsequently is quenched with water and, furthermore, with air, wherein the welding connection with the standard rail, after cooling, is advantageously annealed at 200° C. to 600° C. for tempering. Likewise, the welding connection with the manganese steel casting, after cooling, may advantageously be annealed at 200° C. to 600° C. for tempering. With such a mode of procedure, the length of the intermediate piece may, for instance, be about 50 mm, wherein an increase in the tensile strength to 600 to 800 N/mm² will be achieved by a simple hardening treatment as is, for instance, realized by an explosion-hardening process. According to the invention it is, therefore, advantageously proceeded in a manner that the intermediate piece is subjected to a hardening treatment prior to or after welding, an explosion-hardening process being feasible either in the unwelded state of the intermediate piece or in the state already welded with the workpiece.

1. Use of an intermediate piece for connecting a molded article of manganese steel with a standard rail made of carbon steel, wherein said intermediate piece is comprised of steel from the group of austenitic-ferritic duplex steels having a ferrite portion of less than 60 weight percent.

2. Use of an intermediate piece according to claim 1, wherein said intermediate piece is comprised of steel having a directional analysis of:
C max 0.03 weight %;
Cr 21-23 weight %;
Ni 4.5-6.5 weight %;
Mo 2.5-3.5 weight %; and
N 0.1-2.22 weight %.

3. Use of an intermediate piece according to claim 1, wherein the intermediate piece is solution-annealed and subsequently quenched.

4. Use of an intermediate piece according to claim 1, wherein the intermediate piece is solution-annealed at 900° C. to 1100° C., and subsequently quenched with water, and further quenched by air.

5. Use of an intermediate piece according to claim 1, wherein the molded article of manganese steel is an austenitic manganese steel casting frog.

6. Use of an intermediate piece according to claim 2, wherein the intermediate piece is solution-annealed and subsequently quenched.

7. Use of an intermediate piece according to claim 2, wherein the intermediate piece is solution-annealed at 900° C. to 1100° C., and subsequently quenched with water, and further quenched by air.

8. A method for connecting an austenitic manganese steel casting with a standard rail made of carbon steel, comprising the step of welding an austenitic-ferritic intermediate piece comprised of duplex steel comprising less than 60 percent ferrite with the manganese steel casting and the standard rail.

9. A method according to claim 8, wherein the intermediate piece has a directional analysis of:
C max 0.03 weight %;
Cr 21-23 weight %;
Ni 4.5-6.5 weight %;
Mo 2.5-3.5 weight %; and
N 0.1-2.22 weight %;
and wherein the intermediate piece is initially welded with the standard rail and subsequently welded with the austenitic manganese steel casting.

10. A method according to claim 8, wherein the intermediate piece is cooled with compressed air during the welding step.

11. A method according to claim 8, wherein, before the welding step, the intermediate piece is solution-annealed at 900° C. to 1100° C. and is subsequently quenched with water and further quenched by air.

12. A method according to claim 8, wherein, after the welding step, the welded connection with the standard rail is cooled and then is annealed at 200° C. to 600° C. for tempering.

13. A method according to claim 8, wherein, after the welding step, the welded connection with the manganese steel casting is cooled and then is annealed at 200° C. to 600° C. for tempering.

14. A method according to claim 8, wherein the intermediate piece is subjected to a hardening treatment prior to or after the welding step.

15. A method according to claim 9, wherein the intermediate piece is cooled with compressed air during welding.

16. A method according to claim 9, wherein, before welding, the intermediate piece is solution-annealed at 900° C. to 1100° C. and is subsequently quenched with water and further quenched by air.

17. A method according to claim 10, wherein, before the welding step, the intermediate piece is solution-annealed at 900° C. to 1100° C. and is subsequently quenched with water and further quenched by air.

18. A method according to claim 9, wherein the welded connection with the standard rail is cooled and then is annealed at 200° C. to 600° C. for tempering.

19. A method according to claim 9, wherein the welded connection with the manganese steel casting is cooled and then is annealed at 200° C. to 600° C. for tempering.

20. A method according to claim 9, wherein the intermediate piece is subjected to a hardening treatment prior to or after welding.
